(19) United States
(12) Patent Application Publication
(10) Pub. No.: US 2014/0286007 A1
(43) Pub. Date: Sep. 25, 2014

(54) Light-Emitting Module and Luminaire

(71) Applicant: Toshiba Lighting & Technology Corporation, Yokosuka-shi (JP)

(72) Inventor: Tsuyoshi Oyaizu, Yokosuka-shi (JP)

(73) Assignee: TOSHIBA LIGHTING & TECHNOLOGY CORPORATION, Yokosuka-shi (JP)

(21) Appl. No.: 14/027,640

(22) Filed: Sep. 16, 2013

(30) Foreign Application Priority Data
Mar. 25, 2013 (JP) 2013-062607

(51) Int. Cl. F21K 99/00

(52) U.S. Cl. CPC F21K 9/56
USPC 362/231

(57) ABSTRACT

According to one embodiment, a light-emitting module includes a plurality of kinds of light-emitting elements having different light emission colors. The light-emitting module includes a substrate on which a plurality of light-emitting element groups are dispersedly arranged, each of the light-emitting element groups organized of the same kind of light-emitting elements, that are at least one kind of light-emitting elements among the plurality of kinds of light-emitting elements, which are close to each other to constitute one group.

### CROSS-REFERENCE TO RELATED APPLICATIONS

This application is based upon and claims the benefit of priority from Japanese Patent Application No. 2013-062607, filed on Mar. 25, 2013; the entire contents of which are incorporated herein by reference.

### FIELD

Embodiments described herein relate generally to a light-emitting module and a luminaire.

### BACKGROUND

In recent years, a luminaire including an LED (Light Emitting Diode) as a light source has been spreading. As the luminaire, a luminaire including a plurality of kinds of LEDs having different light emission colors is known. The luminaire irradiates light of a color obtained by mixing the light emission colors of the LEDs. However, when the luminaire of this type is used, lights of the different colors may not be mixed with each other. Therefore, it is likely that color irregularity occurs on a lighting surface.

### BRIEF DESCRIPTION OF THE DRAWINGS

FIG. 1 is a side view illustrating an outer appearance example of a luminaire of an embodiment.

FIG. 2 is a perspective view illustrating a decomposition example of the luminaire of the embodiment.

FIG. 3 is a front view illustrating the light-emitting module of the embodiment.

FIG. 4 is a front view illustrating the light-emitting module of the embodiment.

FIG. 5 is a longitudinal sectional view illustrating the light-emitting module of the embodiment.

### DETAILED DESCRIPTION

A light-emitting module 100 according to an embodiment described below includes a plurality of kinds of light-emitting elements having different light emission colors. For example, the light-emitting module 100 includes blue LEDs 121 and red LEDs 122 as the plurality of kinds of light-emitting elements. The light-emitting module 100 includes a substrate 110 on which a plurality of light-emitting element groups are dispersedly arranged, each of the light-emitting element groups organized of the same kind of light-emitting elements, that are at least one kind of light-emitting elements among the plurality of kinds of light-emitting elements, which are close to each other to constitute one group.

In the light-emitting module 100 according to the embodiment described below, the plurality of light-emitting element groups include a plurality of different kinds of groups. Besides, the plurality of kinds of light-emitting element groups are respectively dispersedly arranged on the substrate 110.

The plurality of light-emitting elements included in the light-emitting element groups according to the embodiment described below are connected in series to each other.

Each of the plurality of kinds of light-emitting elements according to the embodiment described below is arranged in any one of intersections of imaginary straight lines drawn at equal intervals in a first direction on an arrangement surface of the substrate 110 and imaginary straight lines drawn at equal intervals in a second direction orthogonal to the first direction on the arrangement surface.

The light-emitting module 100 according to the embodiment described below includes a sealing section 150 made of resin configured to integrally seal the plurality of kinds of light-emitting elements.

A luminaire 1 according to an embodiment described below includes any one of the foregoing light-emitting modules 100.

Hereinafter, a light-emitting module and a luminaire according to an embodiment are described with reference to the drawings. In the embodiments, the same components are denoted by the same reference numerals, and signs and redundant explanation of the components is omitted. The number of LEDs illustrated in the figures is not limited to an example illustrated in the figures.

### Outer Appearance Example of Luminaire

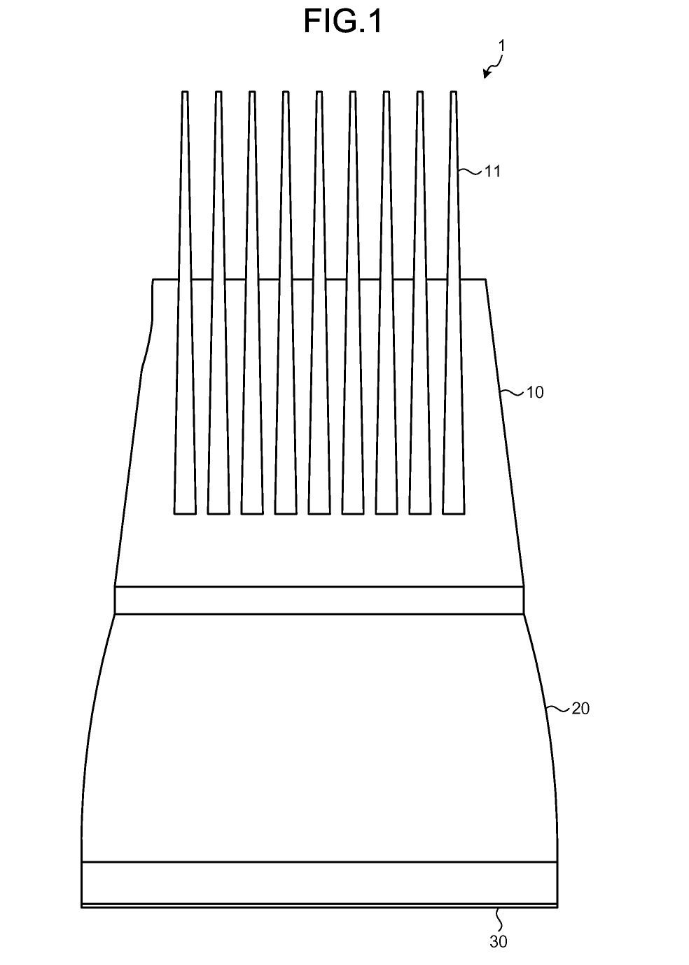

FIG. 1 is a side view illustrating an outer appearance example of a luminaire of an embodiment. The luminaire 1 illustrated in FIG. 1 is a downlight luminaire installed on an indoor ceiling or the like. The luminaire 1 illuminates the inside of a room positioned in a downward direction illustrated in FIG. 1 by causing LEDs mounted therein to emit light. As illustrated in FIG. 1, the luminaire 1 includes a housing 10, a reflector 20 and a cover 30.

The housing 10 is made of a metal having high thermal conductivity and is formed of, for example, aluminum die-casting. A substrate mounted with LEDs is installed inside the housing 10. Besides, a thermal radiation fin 11 to radiate heat generated by the LEDs to the outside is formed on the housing 10. Incidentally, in FIG. 1, although one thermal radiation fin is denoted by reference numeral “11”, each flat plate-shaped member formed on the housing 10 is the thermal ration fin 11.

The reflector 20 is made of a synthetic resin such as ABS (Acrylonitrile, Butadiene, Styrene) resin or a metal such as aluminum die-casting. The reflector performs luminous intensity distribution control by reflecting light emitted from the LEDs in the housing 10.

The cover 30 is attached to a lower surface of the reflector 20, and covers the lower surface of the reflector 20. The cover 30 prevents dust or the like from entering the reflector 20.

### Decomposition Example of Luminaire

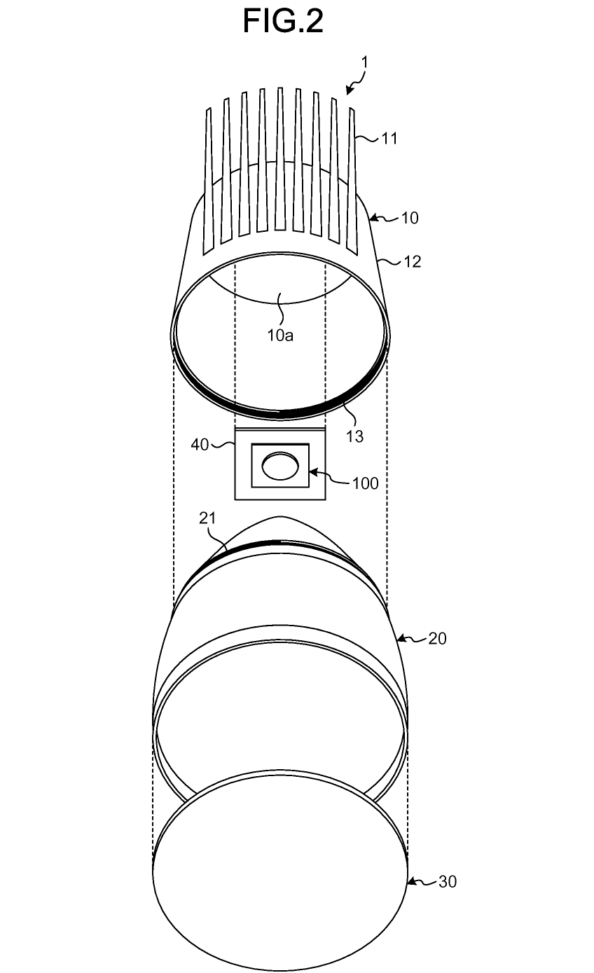

FIG. 2 is a perspective view illustrating a decomposition example of the luminaire 1 of the embodiment. As illustrated in FIG. 2, the housing 10 is formed into a substantially cylindrical shape, and a lower end thereof is opened. Specifically, the housing 10 includes an installation surface 10a and a support part 12 extending from a peripheral part of the installation surface 10a. That is, the installation surface 10a is a bottom wall of the cylindrical housing 10, and the support part 12 is a side wall of the cylindrical housing 10. A light-emitting module 100 is installed on the installation surface 10a of the housing 10 through an adhesive member 40.

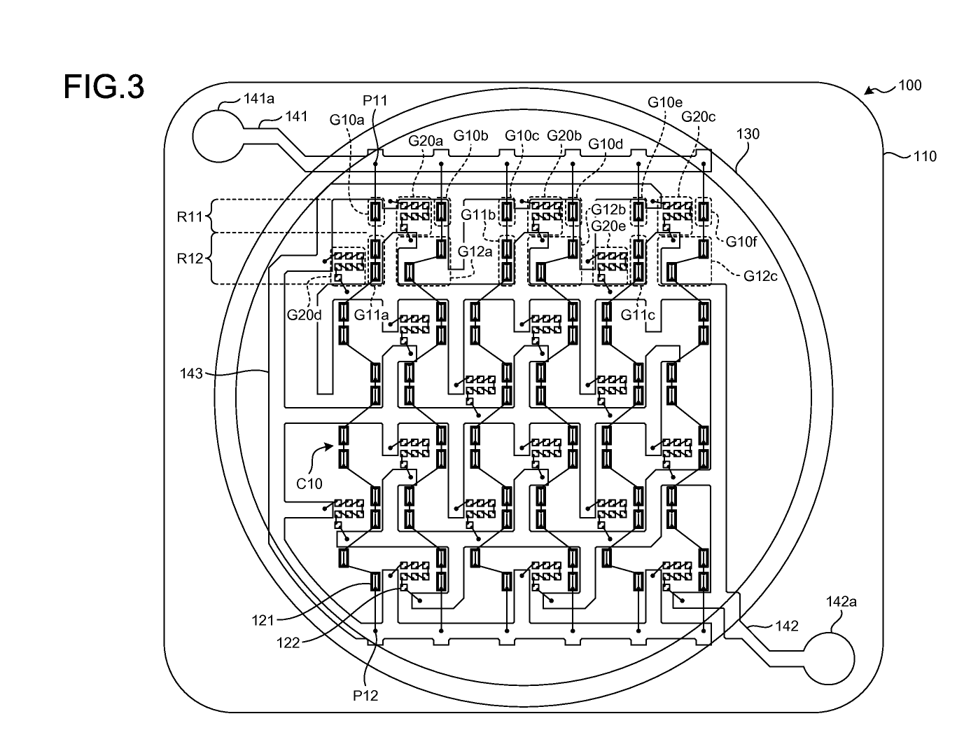

The light-emitting module 100 includes an adhesive surface adhered to the adhesive member 40, and an arrangement surface on the opposite side to the adhesive surface. LEDs as light-emitting elements are arranged on the arrangement surface of the light-emitting module 100. The light-emitting module 100 is connected to an electrical wiring pulled out through a not-illustrated through-hole formed in the installation surface 10a of the housing 10. By this, power is supplied to the light-emitting module 100 from a commercial power supply through the electrical wiring. Incidentally, the light-emitting module 100 will be described later with reference to FIG. 3.

The adhesive member 40 is made of a synthetic resin having high thermal conductivity, and is formed into a plane shape having a size capable of being installed on the installation surface 10a of the housing 10. The adhesive member 40 is in close surface contact with both the installation surface 10a of the housing 10 and the light-emitting module 100, so that the light-emitting module 100 is brought into close contact with the housing 10. By this, since the adhesive member 40 can efficiently conduct heat generated by the light-emitting module 100 to the housing 10, thermal radiation effect can be enhanced.

In the example illustrated in FIG. 2, the support part 12 of the housing 10 includes a screwing part 13 to support the reflector 20. The screwing part 13 has a function as a female screw. The reflector 20 is formed into a cylindrical shape in which both upper and lower ends are opened into a substantially circular shape. The reflector 20 includes a screwing part 21 to be screwed to the screwing part 13 of the housing 10. The screwing part 21 has a function as a male screw. In the luminaire 1 of the embodiment, the screwing part 13 of the housing 10 and the screwing part 21 of the reflector 20 are screwed to each other, so that the support part 12 supports the reflector 20, and the reflector 20 is attached to the housing 10.

The cover 30 is attached to a lower end opening part of the reflector 20. By this, the cover 30 hermetically seals a space formed inside the reflector 20.

### Arrangement Example of Light-Emitting Module

FIG. 3 is a front view illustrating the light-emitting module 100 of the embodiment. FIG. 3 illustrates an example of the light-emitting module 100 seen from below in FIG. 2. As illustrated in FIG. 3, the light-emitting module 100 includes a substrate 110, blue LEDs 121, red LEDs 122, a dam member 130, and wiring patterns 141, 142 and 143. Incidentally, although a region surrounded by the dam member 130 is covered with a sealing section 150 described later, FIG. 3 does not illustrate the sealing section 150.

The substrate 110 is formed of a low thermal conductivity ceramic, for example, alumina, silicon nitride, silicon oxide, aluminum or the like. The plurality of blue LEDs 121 and the plurality of red LEDs 122 are arranged on the substrate 110.

The blue LED 121 is a light-emitting element to emit blue light having a wavelength peak of, for example, 450 nm (nanometer). The red LED 122 is a light-emitting element to emit red light having a wavelength peak of, for example, 635 nm.

Incidentally, in FIG. 3, although one blue LED of the plurality of blue LEDs 121 is denoted by reference numeral 121, similar rectangular parts are the blue LEDs 121. Besides, in FIG. 3, although one red LED of the plurality of red LEDs 122 is denoted by reference numeral 122, similar square parts are the red LEDs 122.

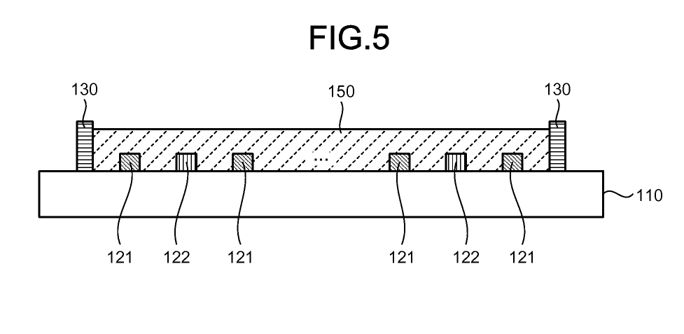

The dam member 130 has a specified height in a direction of separating from the substrate 110, and is formed into a substantially circular shape. The dam member 130 is arranged on the substrate 110 so as to surround the blue LEDs 121 and the red LEDs 122. Incidentally, the dam member 130 will be described later with reference to FIG. 5.

The wiring patterns 141, 142 and 143 are electric conductors printed on the substrate 110. One end 141a of the wiring pattern 141 and one end 142a of the wiring pattern 142 are connected to the electrical wiring pulled out through the through-hole formed in the installation surface 10a of the housing 10.

Here, the plurality of blue LEDs 121 illustrated in FIG. 3 are connected in series by a bonding wire or the like. FIG. 3 illustrates an example in which six series circuits are arranged in each of which thirteen blue LEDs 121 are connected in series. The anodes (positive electrodes) of the series circuits of the blue LEDs 121 are connected to the wiring pattern 141. Besides, the cathodes (negative electrodes) of the series circuits of the blue LEDs 121 are connected to the wiring pattern 143. For example, a series circuit C10 of the thirteen blue LEDs 121 is connected to the wiring pattern 141 at a point P11, and is connected to the wiring pattern 143 at a point P12. Incidentally, in FIG. 3, although there is a portion where the bonding wire in the series circuit C10 intersects the wiring pattern 142 or 143, the series circuit C10 is not connected to the wiring pattern 142 or 143, except for the point P11 and the point P12. Besides, here, although the description is made while using the series circuit C10 as an example, a similar connection mode is established also in the series circuits of the other blue LEDs 121 other than the series circuit C10.

The plurality of red LEDs 122 are connected in series by a bonding wire or the like. FIG. 3 illustrates an example in which eighteen series circuits are arranged in each of which seven red LEDs 122 are connected in series. The anodes (positive electrodes) of the series circuits of the red LEDs 122 are connected to the wiring pattern 143. The cathodes (negative electrodes) of the series circuits of the red LEDs 122 are connected to the wiring pattern 142.

That is, in the case of the example of FIG. 3, current flows from the wiring pattern 141 through the series circuits of the blue LEDs 121, flows through the series circuits of the red LEDs 122 through the wiring pattern 143, and reaches the wiring pattern 142.

Here, in the light-emitting module 100 of the embodiment, a group (hereinafter referred to as a blue LED group) including at least one blue LED 121 and a group (hereinafter referred to as a red LED group) including at least one red LED 122 are formed. The blue LED groups and the red LED groups are arranged on the substrate 110 of the light-emitting module 100 so that the LEDs of different light emission colors are dispersed. This point will be described by use of the example of FIG. 3.

In the example of FIG. 3, each of blue LED groups G10a to G10f includes one blue LED 121. Each of blue LED groups G11a to G11c includes two blue LEDs 121 connected in series in a vertical direction in FIG. 3. Besides, each of blue LED groups G12a to G12c include two blue LEDs 121 connected in series in an oblique direction in FIG. 3. The respective blue LED groups are connected in series to the other blue LED groups, the wiring patter 141 and the wiring pattern 143 by a bonding wire or the like. For example, the blue LED group G10a is connected in series to the wiring pattern 141 and the blue LED group G11a.

In the example of FIG. 3, each of red LED groups G20a to G20e includes seven red LEDs 122 connected in series. The red LED groups are connected in series to the wiring pattern 142 and the wiring pattern 143.

As stated above, the light-emitting module 100 of the embodiment includes the plurality of LED groups each including the same kind of (that is, the same light emission color) LEDs. Incidentally, although the light-emitting module 100 may include an LED group including one LED like the blue LED groups G10a to G10f, the light-emitting module includes at least one group including a plurality of LEDs.

As illustrated in FIG. 3, the blue LED groups and the red LED groups are dispersedly arranged on the substrate 110 of the light-emitting module 100, so that different kinds of LEDs are dispersed. For example, in the example of FIG. 3, when attention is paid to a row R11 on the substrate 110, the blue LED group G10a, the red LED group G20a, the blue LED group G10b, the blue LED group G10c, the red LED group G20b, the blue LED group G10d, the blue LED group G10e, the red LED group G20c and the blue LED group G10f are arranged in order from the left. That is, in the row R11 on the substrate 110, after at least two blue LED groups are continuously arranged, one red LED group is arranged.

For example, in the example of FIG. 3, when attention is paid to a row R12 on the substrate 110, the red LED group G20d, the blue LED group G11a, the blue LED group G12a, the blue LED group G11b, the blue LED group G12b, the red LED group G20e, the blue LED group G11c and the blue LED group G12c are arranged in order from the left. That is, in the row R12 on the substrate 110, after at least four blue LED groups are continuously arranged, one red LED group is arranged.

Although a detailed description is omitted, also in rows other than the above example, a combination of a specified number of blue LED groups and a specified number of red LED groups is sequentially arranged at a specified interval.

As stated above, in the light-emitting module 100 of the embodiment, the blue LED groups and the red LED groups are uniformly dispersedly arranged. By this, according to the light-emitting module 100 of the embodiment, the blue light and the red light can be mixed well. Accordingly, the occurrence of irregular color on an illumination surface (for example, a floor or wall in a room, a desk placed in a room, etc.) illuminated with irradiation light can be prevented.

In the light-emitting module 100 of the embodiment, the blue LED groups and the red LED groups are grouped so that at least one group includes a plurality of LEDs, and are arranged. Accordingly, the number of arranged LEDs can be flexibly changed. For example, there is a case where irregular color on an illumination surface can be suppressed by changing the number of LEDs belonging to one group according to the distance between the luminaire 1 and the illumination surface. In this case, in the light-emitting module 100 of the embodiment, since the respective groups are dispersedly arranged, the occurrence of irregular color can be suppressed. However, the designer or the like of the light-emitting module 100 can further prevent the occurrence of irregular color on the illumination surface by merely changing the number of LEDs belonging to each group according to the distance between the luminaire 1 and the illumination surface.

Incidentally, in FIG. 3, although the arrangement pattern of the LEDs is described while using one direction (lateral direction) on the substrate 110 as an example, no limitation is made to this example. Specifically, it is sufficient if the blue LED groups and the red LED groups are dispersedly arranged on the substrate 110 of the light-emitting module 100. It is not required that the specified number of blue LED groups and the specified number of red LED groups are arranged in one direction at the specified interval.

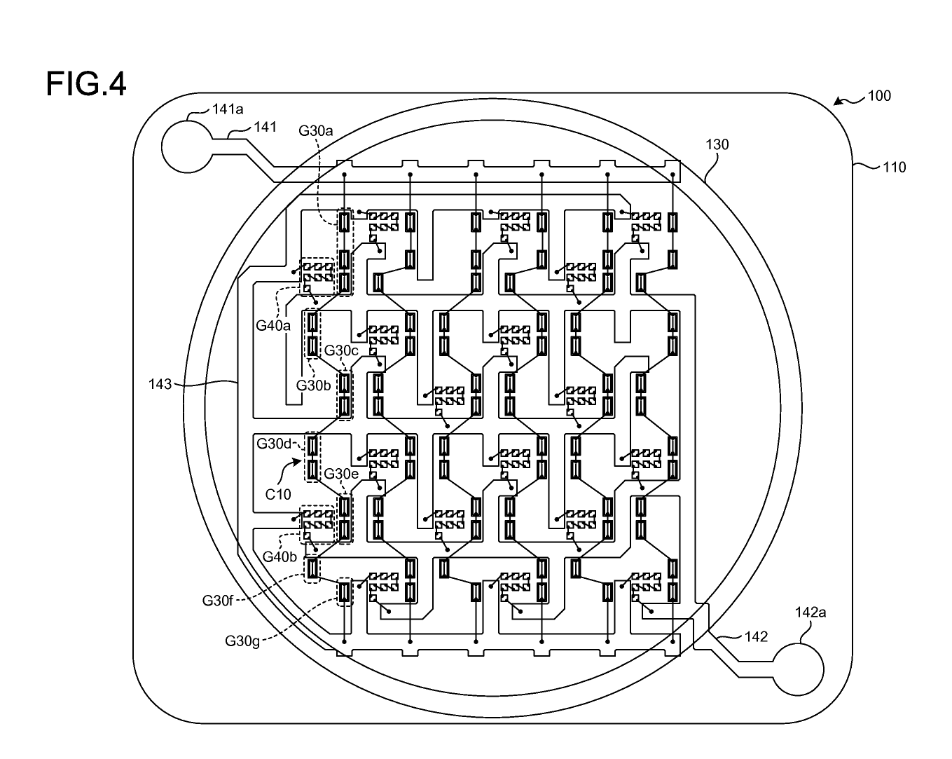

The number of the blue LEDs 121 included in the blue LED group and the number of the red LEDs 122 included in the red LED group are not limited to those of the example illustrated in the drawing. For example, the blue LED groups G10a and G11a illustrated in FIG. 3 may be made one blue LED group. This point will be described by use of an example of FIG. 4.

In the example of FIG. 4, a blue LED group G30a includes three blue LEDs 121 connected in series in the vertical direction. The blue LED group G30a corresponds to the blue LED groups G10a and G11a illustrated in FIG. 3. Besides, in the example of FIG. 4, each of blue LED groups G30b to G30e includes two blue LEDs 121 connected in series in the vertical direction. Besides, each of blue LED groups G30f and G30g includes one blue LED 121. Each of red LED groups G40a and G40b illustrated in FIG. 4 includes seven red LEDs 122 connected in series similarly to the example illustrated in FIG. 3.

Also in the example illustrated in FIG. 4, blue LED groups and red LED groups are dispersedly arranged on a substrate 110 of a light-emitting module 100 so that different kinds of LEDs are dispersed. For example, in the example of FIG. 4, the blue LED groups G30a to G30g constituting a series circuit C10 are respectively arranged in apex sections (folding positions) of zigzag shapes. That is, the blue LED groups G30a to G30g are arranged in a lightening shape.

A red LED group is arranged at a position where the red LED group is surrounded by some blue LED groups. For example, the red LED group G40a is arranged at a position where the red LED group G40a is surrounded by the blue LED group G30a and the blue LED group G30b. Besides, for example, the red LED group G40b is arranged at a position where the red LED group G40b is surrounded by the blue LED group G30d, the blue LED group G30e and the blue LED group G30f . Besides, here, although a detailed description is omitted, another red LED group is also arranged at a position where the red LED group is surrounded by a plurality of blue LED groups. As stated above, the unit of formation of the blue LED group or the red LED group can be arbitrarily changed.

Next, arrangement positions of the blue LEDs 121 and the red LEDs 122 will be described. The blue LEDs 121 and the red LEDs 122 of the embodiment are preferably arranged in any one of intersections of imaginary straight lines drawn at substantially equal intervals in the imaginary direction on the substrate 110 and imaginary straight lines drawn at substantially equal intervals in the lateral direction on the substrate 110. At this time, the blue LEDs 121 and the red LEDs 122 are arranged so that the intersections between the virtual straight lines and the centers of the LEDs coincide with each other. In other words, each of the blue LEDs 121 and the red LEDs 122 is arranged in any one of regions obtained by dividing the arrangement surface of the substrate 110 in units of a specified size. In this case, the specified size of the divided region of the arrangement surface of the substrate 110 is larger than at least the size of the blue LED 121 and the size of the red LED 122.

As stated above, in the light-emitting module 100 of the embodiment, since each of the blue LEDs 121 and the red LEDs 122 is arranged in one of the uniformly divided regions of the arrangement surface of the substrate 110, the number of manufacturing processes can be reduced. Specifically, when the light-emitting module 100 is manufactured, in a process called bonding, the blue LEDs 121 and the red LEDs 122 are arranged on the arrangement surface of the substrate by one row by one row. For example, while parallel movement is performed in a first direction of the substrate 110, the blue LEDs 121 and the red LEDs 122 are arranged in, for example, a second direction orthogonal to the first direction. At this time, when the blue LEDs 121 and the red LEDs 122 are arranged at the intersections between the virtual straight lines as in the above example, the number of rows where the respective LEDs are arranged is small. Thus, the number of manufacturing processes of the light-emitting module 100 can be reduced.

### Sectional Example of Light-Emitting Module

FIG. 5 is a vertical sectional view illustrating the light-emitting module 100 of the embodiment. As illustrated in FIG. 5, the blue LEDs 121 and the red LEDs 122 are arranged on the substrate 110. The annular dam member 130 is arranged on the substrate 110 so as to surround the blue LEDs 121 and the red LEDs 122. A sealing section 150 is provided in a recess formed of an inner surface of the dam member 130 and the substrate 110. Various resins are injected into the recess and are hardened, so that the plurality of kinds of the blue LEDs 121 and the red LEDs 122 are integrally sealed in the sealing section 150. For example, the sealing section 150 is formed of various resins such as epoxy resin, urea resin, silicone resin and transparent resin containing no phosphor and having high diffusivity.

As stated above, the blue LEDs 121 and the red LEDs 122 arranged on the substrate 110 are wholly covered from above by the same sealing section 150. By this, according to the light-emitting module 100 of the embodiment, different color lights are mixed in the sealing section 150 of resin or the like. Accordingly, irradiation lights can be more effectively mixed, and the occurrence of irregular color on the illumination surface can be further prevented.

### Other Embodiments

In the above embodiment, the description is made on the example in which one group includes at least one same kind of LED. However, one group may include different kinds of LEDs. For example, in the example illustrated in FIG. 3, the blue LED group G10a, the blue LED group G11a and the red LED group G20a may form one group. In this case, a plurality of LED groups including different kinds of LEDs are dispersedly arranged on the substrate 110 of the light-emitting module 100 so as to prevent the LED groups from being unevenly distributed.

The arrangement patterns of the LEDs illustrated in FIG. 3 and FIG. 4 are merely examples, and no limitation is made to the examples. For example, in the above embodiment, as in the examples illustrated in FIG. 3 and FIG. 4, the example is described in which the light-emitting module 100 includes the plurality of series circuits in each of which the blue LEDs 121 are connected zigzag and in series to each other. However, the light-emitting module 100 may include a plurality of series circuits in each of which the blue LEDs 121 are connected linearly and in series.

In the above embodiment, the description is made on the example in which the light-emitting module 100 includes the blue LEDs 121 and the red LEDs 122. However, no limitation is made to this example, and the light-emitting module 100 may include an LED to emit light having a color different from blue and red. For example, the light-emitting module 100 may include an LED to emit white or green light.

In the above embodiment, the description is made on the example in which the light-emitting module 100 includes two kinds of LEDs (the blue LEDs 121 and the red LEDs 122). However, no limitation is made to this example, and the light-emitting module 100 may include three or more kinds of LEDs. For example, the light-emitting module 100 may include blue LEDs, red LEDs and white LEDs . Also in this case, in the light-emitting module 100, a plurality of kinds of LED groups are grouped so that at least one group includes a plurality of LEDs, and are dispersedly arranged.

In the above embodiment, the description is made on the example in which the luminaire 1 is of the downlight type. However, the luminaire 1 including the foregoing light-emitting module 100 is not limited to the downlight type. For example, the luminaire 1 can be applied also to a luminaire such as a bulb or a floodlight. Besides, in the above embodiment, although the description is made on the example in which the housing 10 and the reflector 20 are fixed by screwing, no limitation is made to this example. For example, the housing 10 and the reflector 20 may be fixed by adhesion, fitting, locking or the like.

The shapes, the materials, and the quality of materials of the members according to the embodiment are not limited to those of explained in the embodiment and illustrated in the figures. For example, the housing 10, the reflector 20, the cover 30, the dam member 130 and the like may be rectangular, not circular. Besides, for example, the substrate 110 may be circular, not rectangular.

As described above, according to the above embodiment, it is possible to prevent color irregularity from occurring on the lighting surface.

While certain embodiments have been described, these embodiments have been presented by way of example only, and are not intended to limit the scope of the invention. Indeed, the novel embodiments described herein may be embodied in a variety of other formed; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A light-emitting module comprising:
a plurality of kinds of light-emitting elements having different light emission colors; and
a substrate on which a plurality of light-emitting element groups are dispersedly arranged, each of the light-emitting element groups organized of the same kind of light-emitting elements, that are at least one kind of light-emitting elements among the plurality of kinds of light-emitting elements, which are close to each other to constitute one group.

2. The light-emitting module according to claim 1, wherein
the plurality of light-emitting element groups include a plurality of different kinds of groups, and
the plurality of kinds of light-emitting element groups are respectively dispersedly arranged on the substrate.

3. The light-emitting module according to claim 1, wherein the plurality of light-emitting elements included in the light-emitting element groups are connected in series to each other.

4. The light-emitting module according to claim 1, wherein each of the plurality of kinds of light-emitting elements is arranged in any one of intersections of imaginary straight lines drawn at equal intervals in a first direction on an arrangement surface of the substrate and imaginary straight lines drawn at equal intervals in a second direction orthogonal to the first direction on the arrangement surface.

5. The light-emitting module according to claim 1, further comprising a sealing section made of resin configured to integrally seal the plurality of kinds of light-emitting elements.

6. A luminaire comprising a light-emitting module, wherein
the light-emitting module includes
a plurality of kinds of light-emitting elements having different light emission colors, and
a substrate on which a plurality of light-emitting element groups are dispersedly arranged, each of the light-emitting element groups organized of the same kind of light-emitting elements, that are at least one kind of light-emitting elements among the plurality of kinds of light-emitting elements, which are close to each other to constitute one group.

7. The luminaire according to claim 6, wherein
the plurality of light-emitting element groups include a plurality of different kinds of groups, and
the plurality of kinds of light-emitting element groups are respectively dispersedly arranged on the substrate.

8. The luminaire according to claim 6, wherein the plurality of light-emitting elements included in the light-emitting element groups are connected in series to each other.

9. The luminaire according to claim 6, wherein each of the plurality of kinds of light-emitting elements is arranged in any one of intersections of imaginary straight lines drawn at equal intervals in a first direction on an arrangement surface of the substrate and imaginary straight lines drawn at equal intervals in a second direction orthogonal to the first direction on the arrangement surface.

10. The luminaire according to claim 6, wherein the light-emitting module further includes a sealing section made of resin configured to integrally seal the plurality of kinds of light-emitting elements.
